(19) United States
(12) Patent Application Publication
(10) Pub. No.: US 2019/0385470 A1
(43) Pub. Date: Dec. 19, 2019

(54) TIME-CONSTRAINED PERSONALIZED LEARNING ACTIVITIES IN ONLINE EDUCATION PLATFORMS

(71) Applicant: Chegg, Inc., Santa Clara, CA (US)

(72) Inventor: Vincent Le Chevalier, San Jose, CA (US)

(21) Appl. No.: 16/012,403

(22) Filed: Jun. 19, 2018

(51) Int. Cl. G09B 5/06; G06F 17/30; G06Q 50/20

(52) U.S. Cl. CPC G09B 5/065; G06Q 50/205; G09B 5/067; G06F 17/30867

(57) ABSTRACT

A method of automatically providing personalized learning activities to users of an online learning platform is described. An input of an educational objective and a finite duration of time for completion of the educational objective is received. An effective time available to the user for rendering a playlist of educational content files is calculated. A plurality of educational content files that meet the educational objective is selected from an educational content repository. A subset of educational content files is selected from the plurality based on a learning profile associated with the user and time needed for rendering. An ordered playlist of the educational content files in the subset is generated, such that the ordered playlist is estimated to be rendered by the user within the effective time and is optimized to achieve the educational objective for the user.

### TECHNICAL FIELD

This disclosure relates to automatically providing personalized learning activities to users of an online learning platform.

### BACKGROUND

Systems that provide users with recommended content, such as news articles, and other suggested reading, exist. However, students using an online learning platform, may wish to receive recommendation for content that is time constrained. For example, a student may wish to receive recommendation for content so that they may prepare for an upcoming exam and may have limited time to do so.

Accordingly, there is a need for an online learning platform that provides time-constrained personalized learning activities to users of an online learning platform.

### BRIEF DESCRIPTION OF THE DRAWINGS

For a better understanding of the various described implementations, reference should be made to the Detailed Description below, in conjunction with the following drawings.

FIG. 1 illustrates an online education system 100 in accordance with some embodiments.

FIG. 2 is a flowchart illustrating a method 200 of processing content in content repository 120 in accordance with some embodiments.

FIG. 3 depicts a block diagram for an example data structure for the content repository 120 for storing educational content and learning activity content in accordance with some implementations.

FIG. 4 depicts a block diagram for an example data structure for storing user information in some implementations.

FIG. 5 is a flowchart illustrating a method 500 of determining a user learning profile 430 in accordance with some embodiments.

FIGS. 6A-6D are flowcharts illustrating a method 600 of generating an ordered playlist of time-constrained personalized learning activities for a user in accordance with some embodiments.

FIG. 7 illustrates an interface 700 for presenting an ordered playlist to a user in accordance with some embodiments.

FIG. 8 is a flowchart illustrating a method 800 of generating an ordered playlist of time-constrained personalized learning activities for multiple users in accordance with some embodiments.

FIG. 9 is a block diagram of a server system 900 in accordance with some embodiments.

Like reference numerals refer to corresponding parts throughout the drawings and specification.

### DETAILED DESCRIPTION

Reference will now be made in detail to various embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

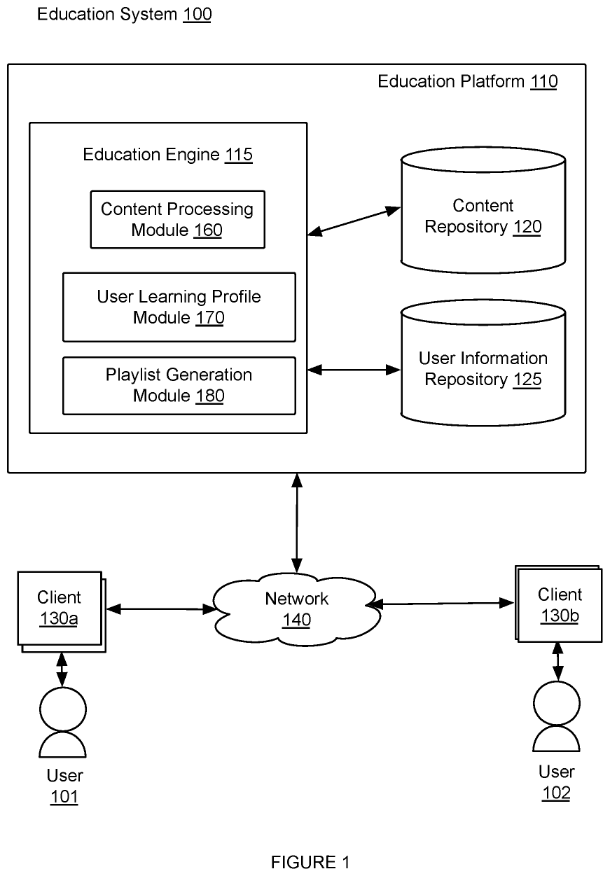

FIG. 1 illustrates an online education system 100 in accordance with some embodiments. Education system 100 includes an education platform 110 that provides personalized education activities to a plurality of users, including users 101 and 102. In some implementations, thousands, even millions of users use education platform 110 to access educational content.

The education platform 110 is communicatively coupled to client devices 130 and 132 via a network 140. A client 130 accesses digital content from education platform 110 through network 140 and presents digital content to a user 101. Example client devices 130 include a desktop, a laptop, a tablet, a mobile device, smartphone, a smart television, a wearable device, a virtual reality device, etc. Client 130 may include software, such as a web browser or other application for rendering digital content. A particular user 101 may access education platform 110 using one or more client devices 130 and may even start a session with education platform 110 with a first client device (e.g., laptop) and continue the session with a second client device (e.g., mobile device). FIG. 1 illustrates only two users 101 and 102 with respective client devices 130a and 130b. But, there could be thousands, even millions of users, each with one or more associated client devices.

Network 140 enables communications among the entities connected to them through one or more local-area networks and/or wide-area networks. In one embodiment, network 140 is the Internet and uses standard wired and/or wireless communications technologies and/or protocols. Data exchanged over the network 140 can be represented using technologies and/or formats including hypertext markup language (HTML), extensible markup language (XML), and/or JavaScript Object Notation (JSON). In addition, all or some of the transmitted data can be encrypted using conventional encryption technologies such as the secure sockets layer (SSL), transport layer security (TLS), virtual private networks (VPNs), and/or Internet Protocol security (IPsec). In another embodiment, the entities use custom and/or dedicated data communications technologies instead of, or in addition to, the ones described above.

Education platform 110 stores educational content items and serves these items to users of client devices 130 in accordance with some implementations. In the illustrated embodiment, the education platform 110 includes a content repository 120, a user information repository 125, and an educational content and learning activities engine 115, referred to as the education engine 115 hereafter. In some implementations (not illustrated), content repository 120 or a portion thereof, is provided by a third-party (not shown) and may be communicatively networked with education engine 115, such as, via network 140.

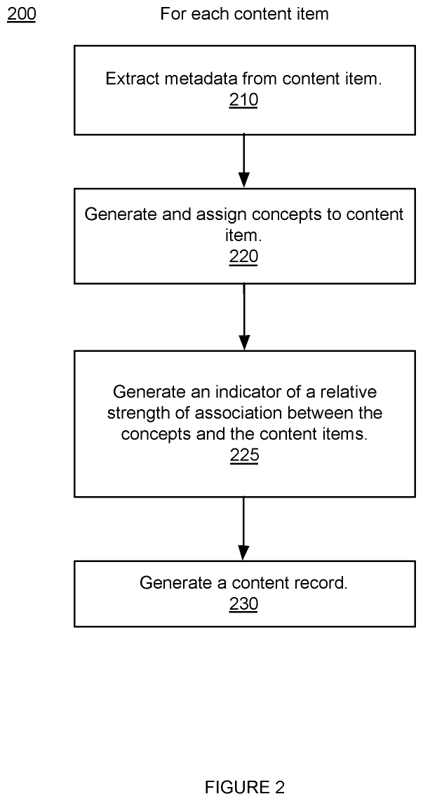

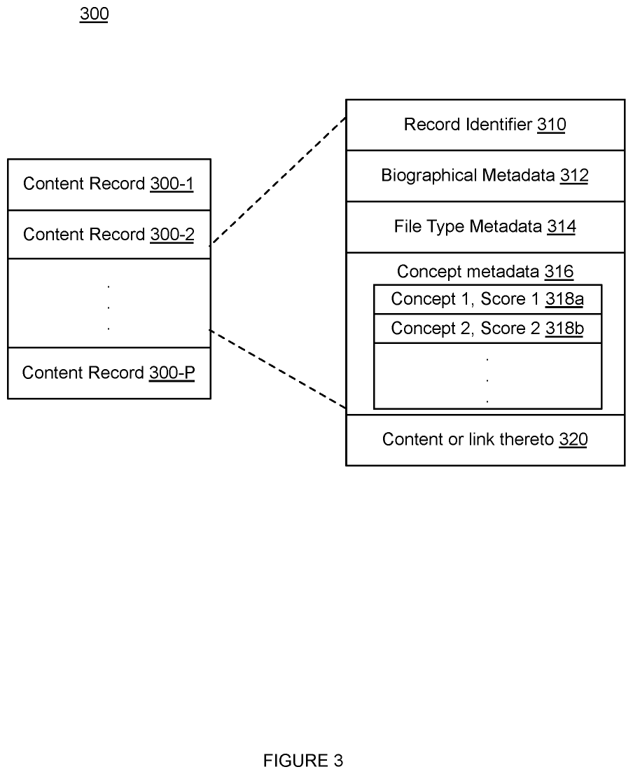

In some implementations, content repository 120 includes a number of content entities, each content entity including content of a similar type, such as textbooks, courses, jobs, and videos. Accordingly, a textbooks content entity is a set of electronic textbooks or portions of textbooks. A courses content entity is a set of documents describing courses, such as course syllabi. A jobs content entity is a set of documents relating to jobs or job openings, such as descriptions of job openings. A videos content entity is a set of video files. An image content entity is a set of images, such as JPEGs, PNGs, etc. Content repository 120 may include numerous other content entities, such as, a massive online open course (MOOC) content entity, a question and answer content entity, a user-generated content entity, white papers, study guides, or web pages. Furthermore, custom content entities may be defined for a subset of users of the education platform 110, such as sets of documents associated with a particular topic, school, educational course, or professional organization. The documents associated with each content entity may be in a variety of different formats, such as plain text, HTML, JSON, XML, or others. Content repository 120 is discussed further with reference to FIGS. 2 and 3. In some embodiments, content in the content repository 120 is acquired from professional content creators, such as book publishers, professors, teachers, production companies, record labels, etc., or from users 101, such as, when a user 101 uploads student notes, a draft of an essay, an assignment, etc. to education platform 110.

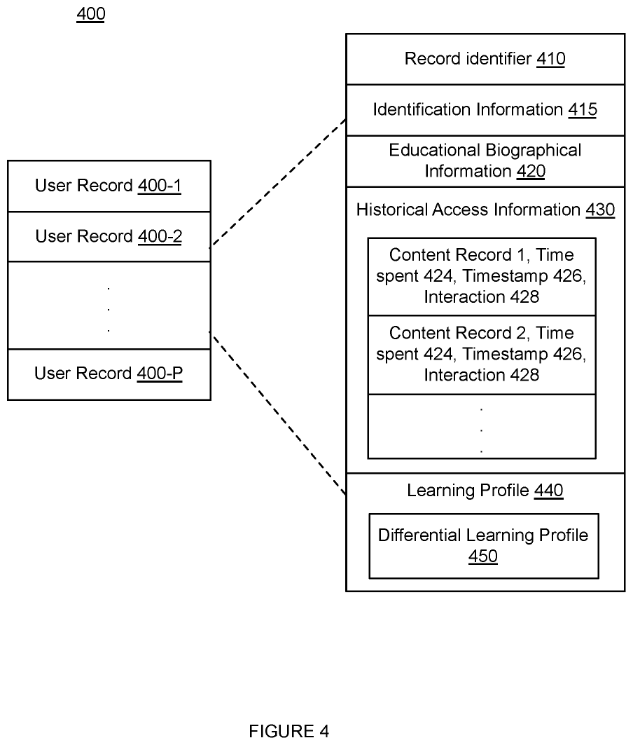

User information repository 125 stores information for each user of education platform 110, such as for users 101 and 102, and is discussed further with reference to FIG. 4.

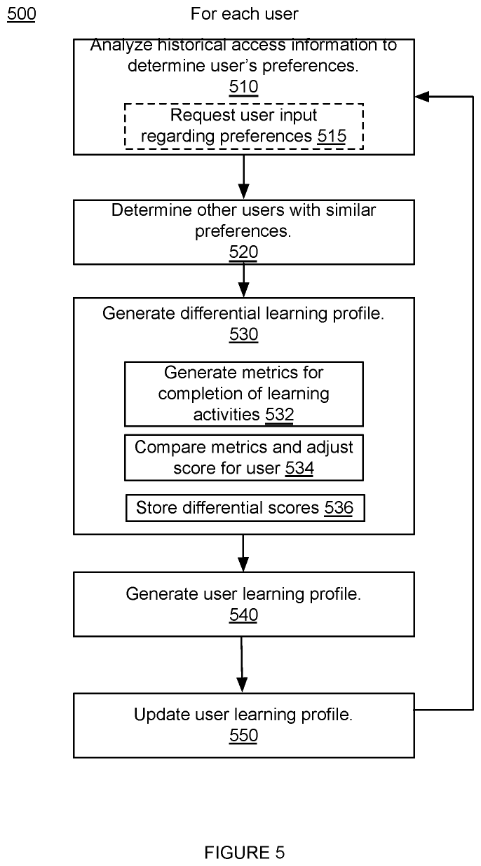

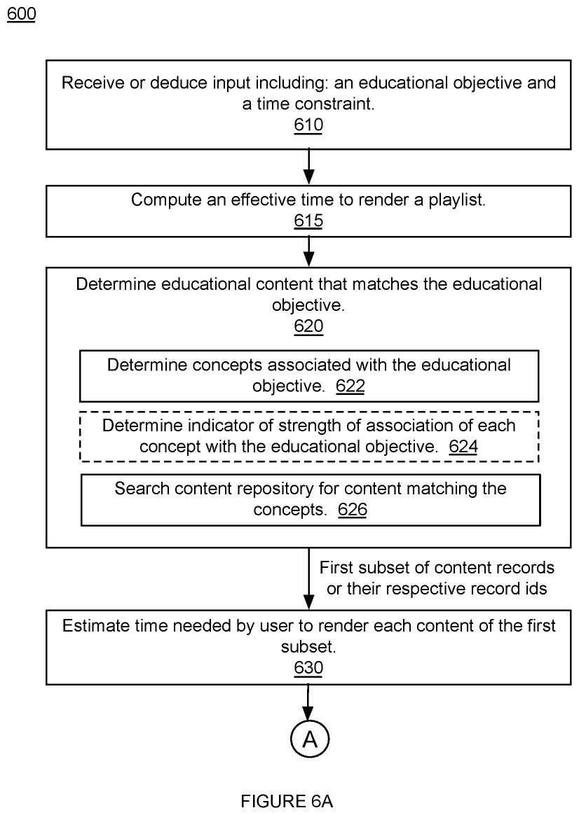

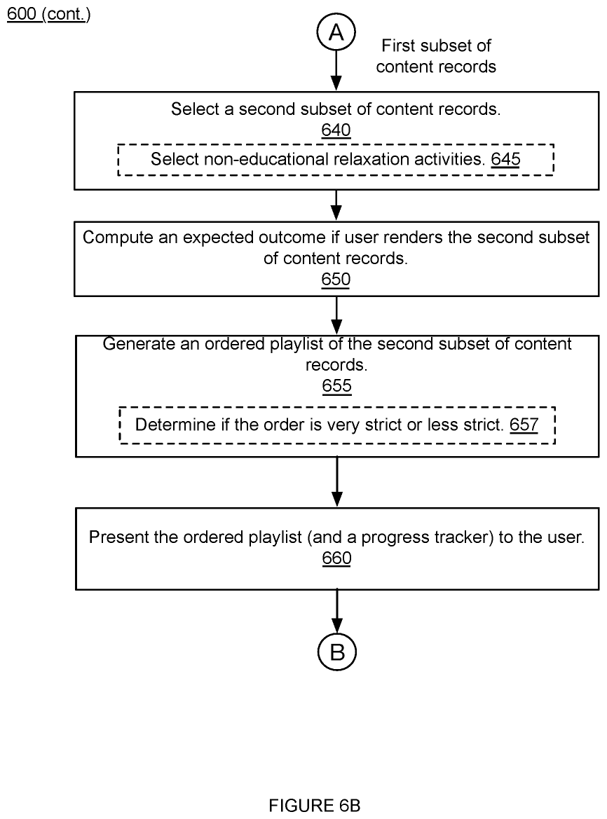

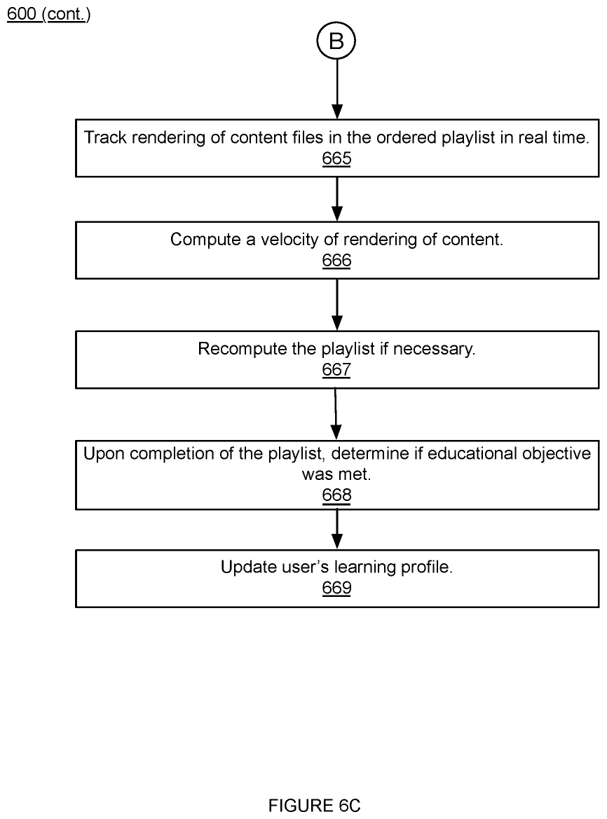

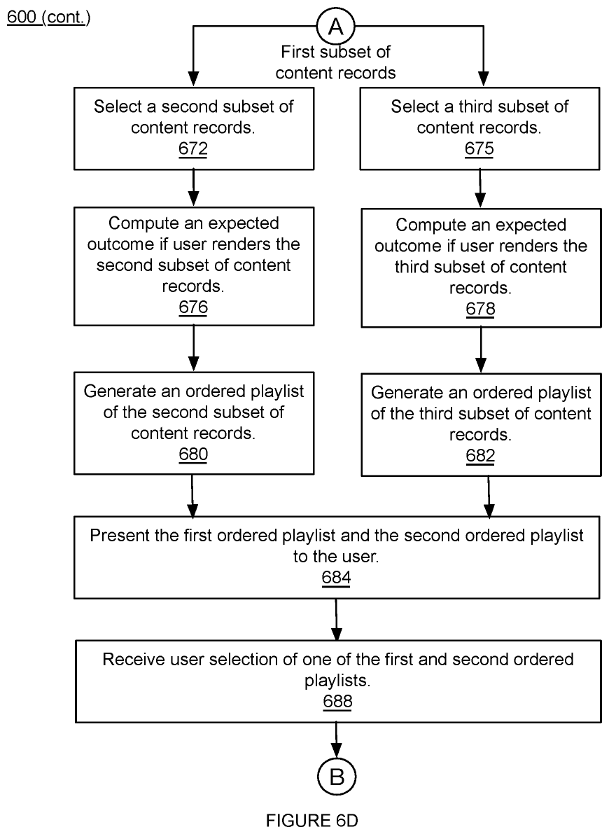

Education engine 115 provides time-constrained personalized learning activities to users of education platform 110 and is discussed further with reference to FIGS. 3-8. In some implementations, education engine 115 employs Artificial Intelligence techniques such as machine learning and iterative learning. Examples of such techniques include, but are not limited to, expert systems, case-based reasoning, Bayesian networks, behavior-based AI, neural networks, fuzzy systems, evolutionary computation (e.g., genetic algorithms), swarm intelligence (e.g., ant algorithms), and hybrid intelligent systems (e.g., expert inference rules generated through a neural network or production rules from statistical learning). Education engine 115 includes the following modules: content processing module 160, user learning profile module 170, and a playlist generation module 180. Content processing module 160 is discussed further with reference to FIG. 2. User learning profile module 170 is discussed further with reference to FIG. 5. Playlist generation module 180 is discussed further with reference to FIGS. 6-8.

Many conventional features, such as firewalls, load balancers, application servers, failover servers, network management tools and so forth are not shown so as not to obscure the features of the system. A suitable service for implementation of the education platform is the CHEGG® service, found at www.chegg.com; other education platform services are known as well, and can be adapted to operate according to the teaching disclosed here. The term “service” in the context of the education platform 110 represents any computer system adapted to serve content using any internetworking protocols and is not intended to be limited to content uploaded or downloaded via the Internet or the HTTP protocol. The term “module” refers to computer program logic for providing a specified functionality. A module can be implemented in hardware, firmware, and/or software. A module is typically stored on a computer-readable storage medium such as storage device, loaded into a memory, and executed by a processor. In general, functions described in one embodiment as being performed on the server side can also be performed on the client side in other embodiments if appropriate. In addition, the functionality attributed to a particular component can be performed by different or multiple components operating together.

FIG. 2 is a flowchart illustrating a method 200 of processing content in content repository 120. Method 200 is performed, for example, by content processing module 160 of education engine 115. Steps in the method 200 that are not order-dependent may be reordered and steps may be combined or broken out.

At 210, content processing module 160 extracts metadata from content items in content repository 120, such as, title, author, description, keywords, file size, file type, language of content, publisher, and the like. As an example, for a particular book in content repository 120, extracted metadata may include: “Title: Science 101: Biology”, “Author: Ochoa, George”, “Edition: 1”; “ISBN-13: 978-0060891350”; “ISBN-10: 0060891351”; “Series: Science 101”; “Publisher: Harper Perennial”; “Language: English”; “Date of Publication: Jun. 26, 2007”; “File type: Pdf”; “File Size: 3 GB”.

At 220, content processing module 160 generates and assigns concepts to content items using a learned model, according to one embodiment. The learned model may be generated by a model trainer using an ensemble method, such as linear support vector classification, logistic regression, k-nearest neighbor, naïve Bayes, or stochastic gradient descent. As an example, for a particular chapter (say, chapter 1) in a particular book in content repository 120, content processing module 160 assigns the following concepts: process of science, macromolecules, cell, membranes, energy, enzymes, cellular respiration, and photosynthesis.

In some embodiments, concepts generated by content processing module 160 are hierarchical in nature, and the hierarchy is utilized when assigning concepts to a particular content item. For example, if content processing module 160 assigns a child concept is to a document, the corresponding parent concept is automatically assigned.

In some embodiments, concepts generated by content processing module 160 are seeded by information extracted at block 610. For example, say at 610, content processing module 160 extracts an index and a table of contents for a book. The information in the index and the table of contents is then used by content processing module 160 as seeds to generate the concepts assigned to that book.

In some embodiments, content processing module 160 identifies associations between concepts. Using the identified associations, content processing module 160 generates concept pairs, where concepts in a concept pair are related to each other. In one embodiment, content processing module 160 identifies associations between concepts based on a determination that two concepts frequently appear in proximity to one another in content items are likely to be related. Accordingly, in one embodiment, the content processing module 160 identifies associations between concepts appearing in proximity to one another in content items of the content repository 120, such as concepts appearing on the same page or concepts appearing in the same section of two documents. In one embodiment, the content processing module 160 applies an Apriori algorithm to identify concepts appearing in proximity to one another across multiple content items. Other algorithms identifying associations between concepts in the documents of the content repository 120 may alternatively be used.

In some embodiments, for concepts assigned to a particular content item, at 225, content processing module 160 also generates an indicator of a relative strength of association between the concepts and the particular content item. For example, for a first concept that is very strongly associated with the particular document, content processing module 160 may assign, say, a score of 0.99, while for a second concept that is only mildly associated with the particular content item, content processing module 160 may assign a score of 0.4.

In one embodiment, the content processing module 160 determines the indicators of relative strength (e.g., scores of 0 to 1) using one or more interestingness measures, such as support, confidence, lift, and conviction. The support supp(x) for a concept x is given by the probability P(x) of the concept occurring in a given document. The confidence conf(x→y) for a concept y occurring in a document given the occurrence of concept x in the document is defined by the conditional probability of y given x, or P(x and y)/P(x). The lift lift(x→y) for a concept y occurring in a document given the occurrence of concept x is given by the observed support for x and y in the document as a ratio of the expected support if x and y were independent concepts, or P(x and y)/[P(x)P(y)]. The conviction conv(x→y) is given by a ratio of the expected frequency of concept x occurring in a document without concept y (assuming x and y are independent concepts) to the observed frequency of x without y, or P(x)P(not y)/P(x and not y).

At 230, for each content item in the content repository 120, content processing module 160 generates a content record 300, which is discussed further with reference to FIG. 3. Concepts assigned at block 220 are stored as concept metadata 316.

The process shown in FIG. 2 is repeated until content records are created and concepts stored for content items in the content repository 120. Similarly, when new content is added to the content repository 120, the processing module 150 assigns concepts to these documents and creates corresponding content records by the process shown in FIG. 2. Further, as the learned model updates itself, concepts stored in the content records are also updated.

FIG. 3 depicts a block diagram for an example data structure for the content repository 120 for storing educational content and learning activity content in accordance with some implementations. Content repository 120 includes a plurality of content records 300-1 to 300-P, each of which corresponds to a discrete content unit. In some implementations, content repository 120 stores extremely large number of content records, such as in the millions, billions, etc. In some implementations, each content record 300 for a content unit includes: a unique record identifier 310 that identifies the particular content record; biographical metadata 312 associated with the content, such as, author, title, keywords, date of creation, date of upload to education platform 110, a description, a file size, and so on, as extracted at block 210; type metadata 314 associated with the content that identifies a type or format of the content, as extracted at block 210; concept metadata 316 determined by content processing module 160 at block 220 and optionally, indicators 318 of relative strength of association of concepts to the content in the content record; and content 320 or a link thereto.

Referring to type metadata 314, the type or format of a content unit is that of digital media and may include, without limitation, text content, image content (e.g., a JPEG or GIF file), audio content, video content, hypertext protocol content, and so on, or any combination of these kinds of content. Content may also include instruction-bearing content, such as machine-readable program code, markup language content, script content, and so forth.

Content record 300 also includes content 320. Content 320 may refer to a book of chapters (e.g., an “eBook”), a chapter of a book, a section within a chapter of a book (such as, questions at the end of the chapter), an issue of a magazine, an entire music album, a song in an album, user-generated notes, etc. In some implementations, the content record 300 does not include the content 320, but instead includes a pointer or link to or other address of content 320, in which case the content itself can be stored outside of the content repository 120, e.g., on a third party server or repository (not shown).

Referring again to FIG. 1, educational platform 110 includes a user information repository 125, which stores a user record associated with each user (e.g., users 101 and 102) of education system 100. FIG. 4 depicts a block diagram for an example data structure for the user information repository 125 for storing user information for each user 101 in some implementations. User information repository 125 includes a plurality of user records 400-1 to 400-P, each of which corresponds to a user 101.

A user record 400 may include: a unique record identifier 410 that identifies the particular user record; identification information 415 for the user, such as, the user's name, email address, address, mobile device number, etc.; educational biographical information 420; and historical access information 430 including records of user's activities on the educational platform 110.

Educational biographical information 420 may include historical and current biographical information, such as universities attended by the user, courses taken, grades in those courses, courses currently registered for, major(s) declared, degree(s) obtained, degree(s) user wishes to obtain, and so on. Educational biographical information 420 may also include a calendar of user's personal, social, and educational commitments, such as upcoming assignment deadlines, upcoming exam deadlines, etc.

Historical access information 430 indicates which content 320 (or associated content records 300 as identified by their unique content identifiers 310) in content repository 120 has been accessed by user 101. Access information 430 may also indicate amount of time spent 424 by user 101 on each content, and optional timestamps 426 of time of access. Access information 430 may also indicate attributes of interaction 428 by user 101 with content 322. In some embodiments, attributes of interaction 438 indicates whether the user's activity was passive, active, or recall.

Passive activities include a user's passive interactions with content in content repository 120, such as, when a user reads a textbook. As another example, when content 322 is a video file, attributes of interaction 438 may indicate that the user 101 watched the video, skipped portions of the video, favorited the video, gave the video a favorable or an unfavorable rating, and so on.

Activities are defined as “active” when a user creates new own user generated content, such as, personal notes, highlights, and other comments, asking questions when help is needed, solving problems, and connecting and exchanging feedback with peers, among others.

Recall activities tests a user against knowledge acquired from passive and active activities. In some cases, recall activities are used for evaluating student performance in the context of an educational course, and may include homework assignments, tests, quizzes, and the like. In other cases, users complete recall activities to study information learned from their passive activities, for example by using flashcards, solving problems provided in a textbook or other course materials, or accessing textbook solutions.

A user record 400 may further include a learning profile 440 for user 101. The determination of learning profile 440 by education platform 110 is described further with reference to FIG. 5. Learning profile 440 may indicate one or more preferred modes of learning for user 101 and may indicate preferences for: type of activity preferred (e.g., active, passive, or recall), type of content (e.g., video, lecture, book, etc.), duration of activity (short vs. long), and so on. For example, one user may learn better by watching videos, while another may learn better by reading text. In another example, one user may learn better if learning sessions are frequently interspersed with non-learning recreational sessions, while another may learn better with long undisturbed sessions. In another example, one user may learn better by repetition or refreshing of previously learned material, while another may prefer mostly or all new material. In yet another example, user 101 may have different preferred modes of learning for different subjects, courses, topics within a subject or course, or even concepts within a subject or course. In yet another example, user 101 may have different preferred modes of learning at different times. For example, at the beginning of an academic term, user 101 may prefer a first mode of learning (such as, a recall activity comprising refresh of material learned in a preceding class, use of a lot of exercises to learn new topics), and at the end of an academic term, user 101 may prefer a second mode of learning (such as, a recall activity comprising refresh of material learned in current class).

In some embodiments, learning profile 440 optionally includes a differential learning profile 450. The determination of differential learning profile 450 by education platform 110 is described further with reference to FIG. 5.

FIG. 5 is a flowchart illustrating a method 500 of determining a user learning profile 430. Method 500 is performed, for example, by user learning profile module 170 of education engine 115. Steps in the method 500 that are not order-dependent may be reordered and steps may be combined or broken out.

In some implementations, learning profile module 170 generates a user learning profile using a learned model, according to one embodiment. The learned model may be generated by a model trainer using an ensemble method, such as linear support vector classification, logistic regression, k-nearest neighbor, naïve Bayes, or stochastic gradient descent.

At 510, learning profile module 170 analyzes a user's historical access information 430 to determine the user's preferences. The learning profile module 170 analyzes the user's activities (e.g., active, passive, or recall), type of content rendered (e.g., video, lecture, book, etc.), duration of activities, etc., to determine the user's preferences.

Optionally, at 515, learning profile module 170 may optionally request user 101 to provide user input regarding that user's preferences. In some implementations, learning profile module 170 requests user 101 to provide user input if there is not enough information in user's historical access information 430, as may be the case for a new or relatively new user 101 of education platform 110.

At 520, learning profile module 170 uses the user's preferences from 510 to determine other user records with similar preferences. In some implementations, learning profile module 170 compares the user's preferences with other users' preferences, and interprets a match over a certain threshold between these preferences as meaning that users have similar preferences.

At 530, learning profile module 170 generates a differential learning profile 450 for user 101. The differential learning profile 450 provides a snapshot of how the user's learning compares with one or more other users with respect to a particular subject, topic, course, concept, etc.

At 532, for two users (one of them being user 101), learning profile module 170 generates one or more metrics for completion of one or more sets of learning activities. Examples of metrics include: time taken to complete each learning activity individually; time taken to complete a particular set of learning activities in aggregate; completion velocity referring to whether the user started slow but then got faster (i.e., accelerated), or started fast but got slow (i.e., decelerated), or stayed the same (i.e., no change); outcome of recall activities in the set of learning activities; outcome of the set of learning activities in aggregate (e.g., student grade); and so on.

In one case, users for generating the differential learning profile 450 are selected based on overlap in learning activities with user 101. Accordingly, differential learning profiles 450 are generated for users with overlap in learning activities. For example, say user 101 is enrolled (or was) enrolled in Bio 101. Accordingly, learning profile module 170 may generate a differential learning profile 450 for user 101 that indicates a difference between the user's learning and that of other users in Bio 101 based on all of the users performing the same activities, such as completing the same assignments, reading the same textbook chapters, and so on. In another case, the user for whom the metrics are generated refers to an average of metrics of all other users, say in Bio 101.

At 534, learning profile module 170 compares the metrics generated at 532 and adjusts a score for user 101 accordingly. The score may be incremented when the metric comparison indicates that user 101 performed better than the other user (or average user), decremented when user 101 performed worse, and not adjusted when the performances were equivalent. The score represents a difference between the learning profile for user 101 and one other user (or average user). Learning profile module 170 may iteratively perform steps 532 and 534 until it determines n differential scores for user 101 representing the difference between the learning profile for user 101 and each other user (n−1) who has completed the or more sets of learning activities at 532, such as each other user in Bio 101.

At 536, learning profile module 170 stores the n differential scores for user 101 as the differential learning profile 450 for particular subject, topic, course, concept, etc. In the example above, the n differential scores for user 101 are stored in association with the course Bio 101.

At 540, learning profile module 170 uses the user's preferences (from 510), the preferences for other similar users (from 520), and the user's differential learning profile 450 to generate a learning profile for the user. Accordingly, learning profile module 170 can expand and/or refine the learning profile for the user using the preferences for other similar users. For example, if a first user has learning preferences A, B, and C that match with a second user who also has learning preferences A, B, and C, but also has a learning preference D, then learning profile module 170 infers that the first user also has learning preference D.

At 550, learning profile module 170 updates the user's learning profile as the user's access information 430 changes, as other similar users' access information 430 changes, as new similar users are added, and as older similar users are no longer considered similar. At 540, learning profile module 170 also updates the user's learning profile based on results of an application of the user's learning profile. As discussed further with reference to FIG. 6, the user's learning profile is used to present a playlist of learning activities to the user. In some implementations, the user's response to the playlist is stored as part of the historical access information 430 and is also used to update the user's learning profile.

The process shown in FIG. 5 is repeated until learning profiles are created and for each user record 400 in user information repository 125. Similarly, when new users access education platform 110 and corresponding new user records are added to the user information repository 125, the learning profile module 170 creates corresponding learning profiles. Further, as the learned model updates itself, learning profiles are also updated.

FIGS. 6A-6C are flowcharts illustrating a method 600 of generating an ordered playlist of time-constrained personalized learning activities for a user. Method 600 is performed, for example, by playlist generation module 170 of education engine 115. Steps in the method 600 that are not order-dependent may be reordered and steps may be combined or broken out.

At 610, an input including at least an educational objective for a first user 101 and a time constraint of a finite duration of time for completion of the educational objective is received. The input can be received from the first user 101, or from another user, such as, the user's professor, in natural language and may indicate an upcoming milestone, such as an exam, mid-term, assignment due date, or simply a user's desire to learn a topic or achieve a goal.

The input of educational objective and the finite duration of time for completion of the educational objective may be explicitly provided. Some examples of such explicit input include: “I have my Bio 101 mid-term in 12 hours. What do I need to learn?”; “My English 101 paper due in 24 hours.”; “I want to learn about cell division in 30 minutes.” Note in all of these examples, the information pair of educational objective and the finite duration of time for completion of the educational objective are explicit: {Bio 101 mid-term, 12 hours}, {English 101 paper, 24 hours}, and {Cell Division, 30 minutes}.

However, at least part or all of the input may not be explicitly provided and may instead be deduced by playlist generation module 170. In one case, playlist generation module 170 accesses a user's upcoming assignment and exam deadlines stored in educational biographical information 420 in user information repository 125 to determine the educational objective and the finite duration of time for completion of the educational objective. For example, the user's upcoming assignment and exam deadlines may indicate that the user's Bio 101 mid-term is in 12 hours, an English 101 paper is due in 24 hours, or that the user may wish to refresh cell division in order to be prepared for an upcoming class in 30 minutes.

At 615, playlist generation module 170 computes an effective amount of time user 101 would have to complete rendering a playlist that the playlist generation module 170 might present to the user 101. In some implementations, the computed effective time is the same as or substantially the same as the finite duration of time received at 610. For example, if the user's Bio 101 mid-term is in 12 hours, the effective estimated amount of time needed to render a playlist is substantially 12 hours. In some implementations, the effective time is a function of the finite duration of time received at block 610, but is not the same or substantially the same as finite duration of time. In one case, the effective time equals the finite duration of time adjusted for the user 101 may need for breaks, sleep, other educational commitments, time for social commitments, etc., as may be deduced from a user calendar stored in biographical information 420, and so on.

At 620, in response to the information received and/or deduced at 610, playlist generation module 170 determines educational content for presentation to user 101, such that the educational content matches the user's educational objective.

At 622, playlist generation module 170 determines one or more concepts associated with the educational objective. For example, the educational objective “Bio 101 mid-term” may indicate the following concepts: process of science, macromolecules, cell, membranes, energy, and enzymes.

In some implementations, playlist generation module 170 determines the one or more concepts belonging to the educational objective using a learned model. The learned model may be generated by a model trainer using an ensemble method, such as linear support vector classification, logistic regression, k-nearest neighbor, naïve Bayes, or stochastic gradient descent.

In addition, or in the alternative, in some implementations, playlist generation module 170 determines the one or more concepts belonging to the educational objective based at least in part on a syllabus, course textbook, handouts, and other educational content associated directly with a student course, e.g., Bio 101 mid-term in the previous example. As an example, the course syllabus for Bio 101 may indicate that the mid-term covers chapters 1, 2, and half of chapter 3 of a particular textbook. Accordingly, playlist generation module 170 determines the one or more concepts belonging to the educational objective of “Bio 101 mid-term” as the concepts covered by chapters 1, 2, and half of chapter 3 of the course textbook. Each of the content items mentioned here, such as, the syllabus, course textbook, handouts, etc. has its own content record 300.

In some implementations, at 624, playlist generation module 170 optionally computes an indicator of a relative strength of association between the concepts and educational objective. For example, for a first concept that is very strongly associated with the playlist generation module 170, playlist generation module 170 may assign, say, a score of 0.99, while for a second concept that is only mildly associated with the particular content item, playlist generation module 170 may assign a score of 0.4.

At 626, playlist generation module 170 searches content repository 120 for content that matches the one or more concepts from block 622. As discussed with reference to FIGS. 2 and 3, concepts metadata 316 is generated and stored for each content in content repository 120. At 626, playlist generation module 170 searches content repository 120 for content records that include the one or more concepts from block 622 in their concepts metadata 216. Continuing the previous example, at 626, playlist generation module 170 searches content repository 120 for content records that include these concepts in their concepts metadata 316: process of science, macromolecules, cell, membranes, energy, and enzymes. Result of the search at 626 returns a first subset of content records in content repository 120. In one case, the result of the search 626 is a list of record ids 310 for the first subset of records.

At 630, playlist generation module 170 estimates an amount of time that would be taken by user 101 to render each content item in the first subset of content records. In some implementations, the estimation of time is based on one or more of the following: user's historical access information 430 indicating how long has the user spent in the past rendering this content (if available), user's historical access information 430 indicating how long has the user spent in the past rendering similar content (if available), historical access information 430 for similar users indicating how long these users have spent rendering this content record, whether the particular content item is new to user 101 or whether it has been previously rendered, and user's learning profile 440. Result of execution of method step 630 is a first subset of content records (or their record ids 310) in content repository 120 and respective time estimated for a user 101 to render the content. Note, that estimation of time at 630 is very personalized and can be very different for two different users.

At 640, playlist generation module 170 selects a second subset of content records from the first subset of content records, where the second subset is estimated to be rendered by user 101 within the computed effective time and is optimized to achieve the educational objective for user 101.

As an example, say the result at 622 is four concepts: A, B, C, and D, and the result at 630 is hundreds of content items, each with its own estimated time of rendering by user 101. At 640, playlist generation module 170 selects ten content items from the hundreds of content items, such that the total estimated time of rendering the ten content items is less than the computed effective time (computed at 615). The ten content items correspond to the four concepts A, B, C, and D. In some implementations, the ten content items are further selected so as to emphasize concepts that are deemed to be important. Accordingly, three of the ten documents may correspond to concept B, which is a concept determined to be very important, based, e.g., on course syllabus (and/or other course materials), similar courses, and/or the user learning profile indicating user's understanding of the concept is weak. In contrast, only a single document of the ten documents may correspond to concept C, which is a concept determined to be less important, based on course syllabus (and/or other course materials), similar courses, and/or user learning profile indicating user's understanding of the concept is strong. In some embodiments, the ten content items are further selected based on attributes of client device. For example, if the user 101 is using a mobile device versus a laptop, the ten content items selected are those that are optimized for being rendered on a mobile device. In some embodiments, the ten content items include items of different types (e.g., video, quizzes, textbook content, etc.).

In some embodiments, the ten content items include items that have previously been accessed by user 101 and new items that have not previously been accessed by user 101, as indicated by user's historical access information 430. The ratio of previously accessed content and new content may be based on the user's learning profile and the computed effective time (computed at 615). For example, if the computed effective time is very small, such as when an exam is only thirty minutes away, there is no time for the user to render new content, especially if the user's learning profile indicates that the user learns better by repetition. Accordingly, the ten content items may exclusively include items that have previously been accessed by user 101 as indicated by user's historical access information.

In some embodiments, optionally at 645, playlist generation module 170 also selects a plurality of non-educational relaxation activities, such as, video games, meditation, music, etc., designed to help the user 101 get necessary breaks so that the user 101 may more effectively retain the educational content in the plurality of educational content items. In some implementations, the non-educational relaxation activities may have respective content records 300 and may even be stored in content repository 120. Continuing the previous example, in addition to the ten content items, playlist generation module 170 selects three non-educational relaxation activities, such that the total estimated time of rendering the thirteen activities (ten content items and three non-educational relaxation activities) is less than the computed effective time.

At 650, playlist generation module 170 generates an outcome that is estimated to occur if user 101 renders each of the second subset of content records within the estimated amount of time needed to render the second subset of content records. For example, the educational objective is an assessment in a particular topic (e.g., a midterm in Bio 101), and the expected outcome is a student grade, such as A, B, etc.

At 655, playlist generation module 170 generates a personalized ordered playlist of the second subset of content records for presentation to the user 101, where the ordered playlist is estimated to be rendered by user 101 within the achieve the educational objective for user 101 and is optimized to achieve the educational objective for user 101.

In some embodiments, playlist generation module 170 determines the order of the ordered playlist based on the importance of the concepts included in the content records in the second subset and the computed effective time. As an example, say the result at 622 is four concepts: A, B, C, and D, and the result at 640 is ten content items. The ten content items correspond to the four concepts A, B, C, and D. If the computed effective time is small (e.g., only thirty minutes remaining), the order of the playlist may be in descending order, with highest score content items being presented first. Accordingly, three of the first ten documents may correspond to concept B, which is a concept determined to be very important and has a high score, as computed at 624. If, on the other hand, the computed effective time is large (e.g., eight hours remaining), the order of the playlist may be not based on the importance of the concepts included in the content records. Rather, the order of the playlist is based on continuity of concepts (e.g., one concept builds on another), distribution of file types (e.g., not all quizzes all at once), and the user learning profile 440.

In contrast, only a single document of the ten documents may correspond to concept C, which is a concept determined to be less important, based on course syllabus (and/or other course materials), similar courses, and/or user learning profile indicating user's understanding of the concept is strong. In some embodiments, the ten content items are further selected based on attributes of client device. For example, if the user 101 is using a mobile device versus a laptop, the ten content items selected are those that are optimized for being rendered on a mobile device. In some embodiments, the ten content items include items of different types (e.g., video, quizzes, textbook content, etc.).

In some embodiments, the ordered playlist includes links or pointers to the second subset of content records, with the corresponding content residing in the content repository 120. In this case, client device would need to remain in communication with education platform 110 via network 140 in order to access the corresponding content. In some embodiments, the ordered playlist comprises content corresponding to the second subset of content records. In this case, client device does not need to remain in communication with education platform 110 via network 140 in order to access the corresponding content and can be offline. In some embodiments, the ordered playlist includes links or pointers to one or more of the second subset of content records, and actual content for the remaining of the second subset of content records.

In some embodiments, the order of the ordered playlist is optimized to achieve the educational objective for user 101 within the time constraints received at block 610. For example, if the time constraint means that there is very little time left for the user to achieve their educational objective (e.g., only 1 hour left before an exam), then the order may emphasize most important concepts and accordingly, first few items in the ordered playlist may correspond to those content records that contain those concepts. As another example, if the time constraint means that there is very little time left for the user to achieve their educational objective (e.g., only 1 hour left before an exam), but the user's learning profile indicates that the user will be unable to learn the most important concepts, then the order may emphasize concepts that the user is familiar with so that the user can refresh those concepts. Accordingly, first few items in the ordered playlist may correspond to those content records dealing with recalling activities related to concepts the user is already familiar with.

Optionally, at 657, playlist generation module 170 determines enforcement rules of the order of the ordered playlist. In some embodiments, the order of the ordered playlist may be either “very strict” or “less strict”. If the order is “very strict”, the playlist must be rendered in the order of the ordered playlist, as the content items in the playlist may build on each other. As such, the user 101 may be unable to change the order, skip content items, or even skip a portion of a content item. If the order is “less strict”, the playlist must be rendered in the order of the ordered playlist, but the user 101 may have some limited rights to change the order, skip content items, or even skip a portion of a content item. In some embodiments, the default enforcement rule is “very strict”.

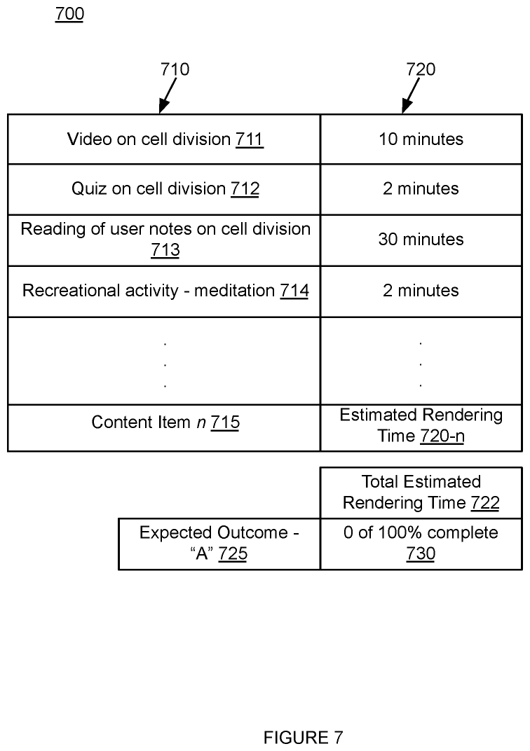

At 660, playlist generation module 170 presents the ordered playlist. In some implementations, concurrently with displaying the ordered playlist to the user 101, playlist generation module 170 displays corresponding expected outcome to the user 101. In some implementations, concurrently with displaying the ordered playlist to the user 101, playlist generation module 170 displays estimated time need to complete rendering the ordered playlist. Further, in some implementations, playlist generation module 170 separately displays estimated time needed to complete each content item in the ordered playlist. FIG. 7 illustrates an interface 700 for presenting an ordered playlist to a user according to some embodiments. In some embodiments, the ordered playlist contains content files (and/or links to content files) of different types. Accordingly, the content files may include at least two of: recall activities, active activities, and passive activities. However, in one particular case, the ordered playlist contains content files and/or links to content files of only recall activities. In this case, the educational objective is an assessment of user 101, such as an exam, mid-term, etc., and may be provided by a user other than user 101, such as his or her professor, teacher, tutor, parent, etc.

The process continues to FIG. 6C, where at 665, playlist generation module 170 tracks rendering of the content files in the ordered playlist by user 101 in real-time. Based on an amount of time that has passed since presenting the ordered playlist to user 101 and a second amount of time estimated to complete rendering of a remainder of the ordered playlist, playlist generation module 170 presents a progress tracker to user 101. The progress tracker may be in the form of a slider, a voice notification, etc. In some implementations, the progress tracker indicates time needed to complete the remainder of the ordered playlist as a whole, while in some implementations, the progress tracker indicates time needed to individually complete the remainder of the content items in the ordered playlist.

At 666, based on results of the tracking at 665, playlist generation module 170 determines a velocity of content rendering. The velocity may show deceleration of content rendering when playlist generation module 170 determines that the user 101 is either very slow in rendering content in the ordered playlist or is slowing down, and as such, the ordered playlist cannot be rendered by user 101 within the finite duration of time. The velocity may show acceleration of content rendering when playlist generation module 170 determines that the user 101 is either fast slow in rendering content in the ordered playlist or is speeding up, and as such, ordered playlist can be rendered by user 101 within the finite duration of time with time left over. A third option for the velocity may be that the user is basically on track and is expected to complete the rendering of the content in the ordered playlist in the effective time (computed at 650).

At 667, based on the velocity of content rendering, playlist generation module 170 determines whether to recompute the playlist. If the velocity indicates deceleration, the playlist generation module 170 may remove one or more educational content files from the remainder of the ordered playlist or may present alternative content files that are estimated to be rendered in a new smaller amount of item. If the velocity indicates acceleration, playlist generation module 170 may add one or more educational content items to the remainder of the ordered playlist, and so on. In some embodiments, upon determining to recompute the playlist, the process may revert to 615 (not shown). In addition, or in the alternative, playlist generation module 170 may determine whether to recompute the playlist based on other factors. One such factor may be the client 130 used by user 101 and/or network connectivity of such client 130. For example, if the user 101 switches client devices 130 during a session with education engine 115, and/or goes from a strong wi-fi connection to a weak cellular connection, playlist generation module 170 may recompute the playlist to provide content that is better suited to the new client device 130 and/or connection. Another factor may be safety and/or privacy. For example, if the user 101 switches client device 130 to say, a network-connected automobile, or to say an iPad in a public bus using the public wi-fi hotspot, may recompute the playlist to provide content that is not as distracting or intrusive (e.g., no video content in a car, public bus, etc.).

In some embodiments, at 668, after the playlist has been rendered by user 101, and/or after the time in the time constraint (received at 610) has passed, playlist generation module 170 determines if the educational objective (received at 610) has been met. For example, in case of the Bio 101 midterm, playlist generation module 170 may access the student grade received. At 669, playlist generation module 170 may update the user's learning profile. Accordingly, if the user 101 achieved their educational objective (e.g., received an “A+ grade” in their Bio 101 midterm), playlist generation module 170 may update the user's learning profile 440 to indicate preference for types of content rendered, etc.

FIG. 6D illustrates an alternate method for the method illustrated in FIG. 6B. The method in FIG. 6D is similar to the one in FIG. 6B, except that playlist generation module 170 selects two subsets of records from the first subset of content records at 672 and 674. Both the second subset and the third subset are estimated to be rendered by user 101 within the computed effective time and optimized to achieve the educational objective for user 101. In some embodiments, the third subset of content records and the second subset of content records have some content records in common but have at least one or more content records not in common. In some embodiments, the third subset of content records differs in complexity and difficulty from the second subset of content records and may require substantially different amount of time to complete rendering. For example, content in the third subset may be easier than content in the second subset and may require less time to complete.

At 676, playlist generation module 170 generates a second outcome that is estimated to occur if the user 101 renders each of the second subset of content records within the estimated amount of time needed to render the second subset of content records. At 678, playlist generation module 170 generates a second outcome that is estimated to occur if the user 101 renders each of the third subset of content records within the estimated amount of time needed to render the third subset of content records. For example, the educational objective is an assessment in a particular topic (e.g., a midterm in Bio 101), and the expected outcome of the user completing rendering of the entire second subset of content records is a first student grade, such as an “A”, and the expected outcome of the user completing rendering of the entire third subset of content records is a first student grade, such as a “B”.

At 680, playlist generation module 170 generates a first ordered playlist of the second subset of content records for presentation to the user 101, where the first ordered playlist is estimated to be rendered by user 101 within the computed effective time and is optimized to achieve the educational objective for user 101. At 682, playlist generation module 170 generates a second ordered playlist of the third subset of content records for presentation to the user 101, where the second ordered playlist is estimated to be rendered by user 101 within the computed effective time and is optimized to achieve the educational objective for user 101. The playlist generation module 170 generates the second ordered playlist, so that the user 101 may be able to choose between the first ordered playlist and the second ordered playlist. The user 101 may for example, decide that they wish to spend a short amount of time and/or achieve a “B” grade corresponding to the second ordered playlist, rather than spend a large amount of time and/or achieve an “A” grade corresponding to the first ordered playlist.

At 684, playlist generation module 170 presents the first ordered playlist and the second ordered playlist to user 101. In some implementations, concurrently with displaying the ordered playlists to the user 101, playlist generation module 170 displays corresponding expected outcomes to the user 101. In some implementations, concurrently with displaying the ordered playlists to the user 101, playlist generation module 170 displays estimated time need to complete rendering each of the ordered playlists. Further, in some implementations, playlist generation module 170 separately displays estimated time needed to complete each content item in each of the ordered playlists.

At 688, playlist generation module 170 receives a selection by user 101 of one of the two ordered playlists presented at 684.

FIG. 7 illustrates a user interface 700 for presenting an ordered playlist 710 to a user 101 according to some embodiments. As illustrated, the ordered playlist 710 includes a list of n content items. One or more of the content items of the ordered playlist 710 may be streamed to the client device 130 or may be downloaded to the client device 130 in the order shown. Accordingly, content item 711 is rendered first, followed by content item 712, and so on. As discussed earlier, the order of rendering of content items in the ordered playlist 710 may be very strict or less strict.

As illustrated in FIG. 7, the content items 710 include content items of differing formats. As an example, content item 711 is a video file, content item 713 may be a word document, and so on. Further, content items 710 include content items that reflect differing types of user interactions. As an example, content item 711 is a passive activity involving the user watching a video, content item 712 is a recall activity involving the user doing a quiz, content item 714 is a recreational activity designed to help the student relax.

In some embodiments, as user 101 renders a content item (say content item 711), the interface 700 is updated so as to show an updated ordered list 710 containing items 712-715, an updated total estimated rendering time 722 for rendering items 712-715, and an updated progress tracker 730 (e.g., 10% of 100% complete). Further, even the content items in the ordered playlist 710 may be updated based on a computed velocity of content rendered, as discussed with reference to FIG. 6C.

Also presented to user 101 is an expected outcome 725, as may be calculated at block 650 of FIG. 6B,. Also shown in FIG. 7 is a progress tracker 730. Here, as the user has not started rendering the playlist, the progress tracker 730 indicates 0% completion. The interface 700 may further present other useful information to user 101, such as individual times 720 for rendering each content item in ordered playlist 710 individually, metadata (not shown) about the each content item in ordered list 710, a preview (not shown) of each content item in ordered list 710, a thumbnail (not shown) for each content item in ordered playlist 710, and the like. In addition or in the alternative, interface 700 may further show user 101 social information related to one or more content items in ordered playlist 710. For example, interface 700 may further show user 101 that a user 102 who is a friend of user 101 is also rendering item 712 concurrently to user 101, or recently rendered item 712. Interface 700 may further allow communication with user 102, thus enabling user 101 to e.g., ask questions, discuss concepts, etc. with user 102.

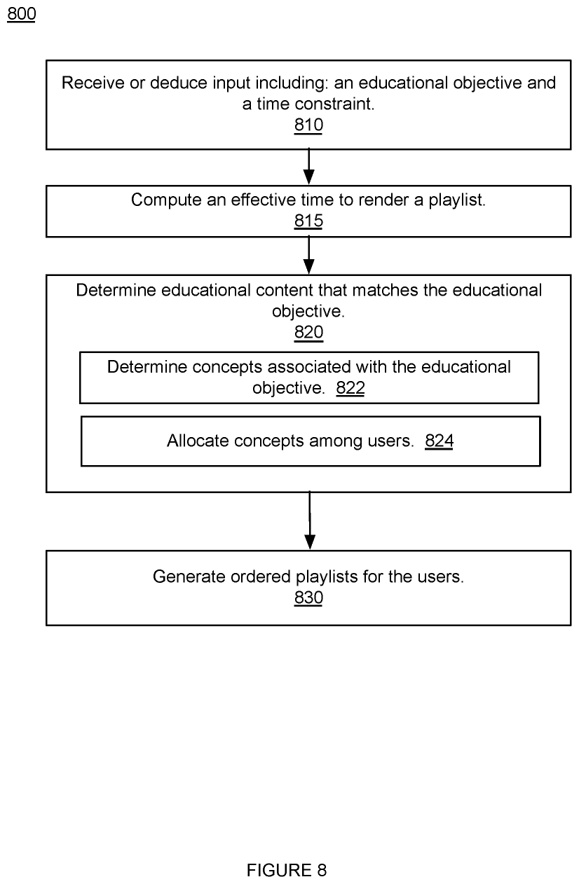

FIG. 8 is a flowchart illustrating a method 800 of generating an ordered playlist of time-constrained personalized learning activities for multiple users. Method 800 is performed, for example, by playlist generation module 170 of education engine 115. Steps in the method 800 that are not order-dependent may be reordered and steps may be combined or broken out. While FIG. 8 and corresponding discussion only illustrates playlist generation and presentation for two users, the method could be used for more than two users.

At 810, an input including at least an educational objective for two users 101 and 102 and respective finite durations of time for completion of the educational objective is received. The input can be received from either of the users 101 and 102 or from another user, such as, the user's professor in natural language via interface 116 and may indicate an upcoming milestone, such as an exam, mid-term, assignment due date, or simply the users' desire to learn a new topic or refresh an old one.

The input of educational objective and the finite duration of time for completion of the educational objective may be explicitly provided. Some examples of such explicit input include: “We have our Bio 101 mid-term in 12 hours. What do we need to learn?; “Our programming project is due in 24 hours”; “We want to learn about cell division in 30 minutes.” Note in all of these examples, the information pair of educational objective and the finite duration of time for completion of the educational objective are explicit: {Bio 101 mid-term, 12 hours}, {English 101 paper, 24 hours}, and {Cell Division, 30 minutes}.

The rest of method 800 is similar to method 600, except at 824, playlist generation module 170 allocates a portion of the concepts to the first user 101 and a remainder of the concepts to the second user 102. This allocation may be based on the users' learning profile, the educational objective, and the time constraints. For example, if the effective time for completion is short, and the educational objective is a shared project (e.g., a programming assignment), then playlist generation module 170 may allocate concepts based on the users' relative strengths. Accordingly, each user may be presented ordered playlists corresponding to concepts that the user is already strong on, as there is no time for the users to learn concepts that they are unfamiliar with.

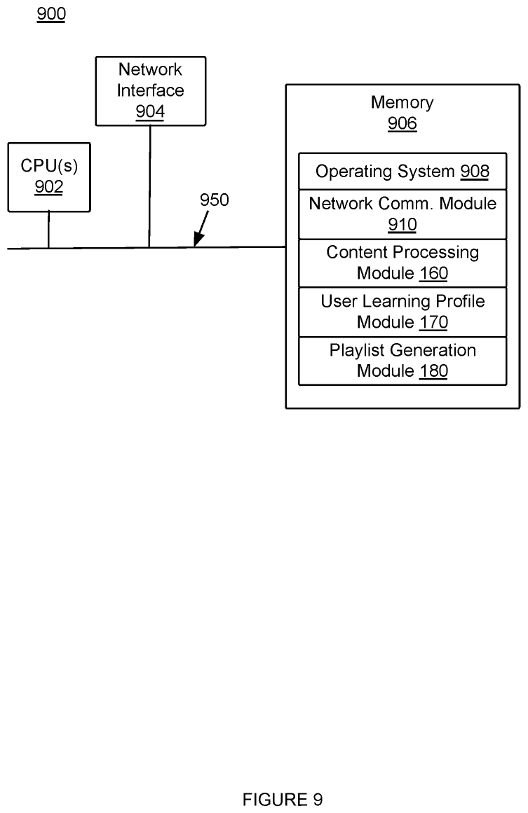

FIG. 9 is a block diagram of a server system 900 in accordance with some embodiments. The system 900 may be an example of the education engine (FIG. 1). The system 900 typically includes one or more processors 902 (e.g., CPUs and/or GPUs), one or more network interfaces 904 (wired and/or wireless), memory 906, and one or more communication buses 905 interconnecting these components.

Memory 906 includes volatile and/or non-volatile memory. Memory 906 (e.g., the non-volatile memory within memory 906) includes a non-transitory computer-readable storage medium. Memory 906 optionally includes one or more storage devices remotely located from the processors 902 and/or a non-transitory computer-readable storage medium that is removably inserted into the server system 900. In some embodiments, memory 906 (e.g., the non-transitory computer-readable storage medium of memory 906) stores the following modules and data:
an operating system 908 that includes procedures for handling various basic system services and for performing hardware-dependent tasks;
a network communication module 910 that is used for connecting the education engine 115 to other computing devices via one or more network interfaces 904 connected to one or more networks 140 (FIG. 1);
content processing module 160 or a portion thereof;
user learning profile module 170 or a portion thereof; and
playlist generation module 180 or a portion thereof.

Each of the modules stored in memory 906 corresponds to a set of instructions for performing one or more functions described herein. Separate modules need not be implemented as separate software programs. The modules and various subsets of the modules may be combined or otherwise re-arranged. In some embodiments, memory 906 stores a subset or superset of the modules and/or data structures identified above.

FIG. 9 is intended more as a functional description of the various features that may be present in a server system than as a structural schematic. In practice, items shown separately could be combined and some items could be separated. For example, some items shown separately in FIG. 9 could be implemented on a single server and single items could be implemented by one or more servers. The actual number of servers used to implement the system 900, and how features are allocated among them, will vary from one implementation to another.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method comprising:
at a server system comprising one or more processors and memory storing instructions for execution by the one or more processors:
receiving an input including an educational objective for a user and a finite duration of time for completion of the educational objective; and
responsive to the input:
computing an effective time available to the user for rendering a playlist of educational content files, wherein the effective time is less than the finite duration of time;
selecting, from an educational content repository, a plurality of educational content files that meet the educational objective,
selecting a subset of educational content files from the plurality of educational content files based on a learning profile associated with the user and that is estimated to be rendered by the user within the effective time,
determining an order for the educational content files in the subset, wherein the order is optimized to achieve the educational objective for the user,
generating, using the order, an ordered playlist of the educational content files in the subset, wherein the ordered playlist is estimated to be rendered by the user within the effective time and is optimized to achieve the educational objective for the user, and
presenting the ordered playlist to the user.

2. The method of claim 1, further comprising:
determining a first outcome that is estimated to occur if the user plays the entirety of the ordered playlist within the effective time; and
concurrent to presenting the ordered playlist to the user, presenting the first outcome to the user.

3. The method of claim 2, wherein the user is a student, the educational objective is an assessment in a particular topic, and the first outcome is a student grade.

4. The method of claim 1, further comprising:
selecting a second subset of educational content files from the plurality of educational content files that is estimated to be rendered by the user within the effective time;
determining a second order for the educational content files in the second subset, wherein the second order is optimized to achieve the educational objective for the user;
generating, using the second order, a second ordered playlist of the educational content files in the second subset, wherein the second ordered playlist is estimated to be rendered by the user within the effective time and is optimized to achieve the educational objective for the user; and
presenting the second ordered playlist to the user.

5. The method of claim 4, further comprising:
determining a second outcome that is estimated to occur if the user plays the entirety of the second ordered playlist within the effective time; and
concurrent to presenting the second ordered playlist to the user, presenting the second outcome to the user.

6. The method of claim 5, wherein the user is a student, the educational objective is an assessment in a particular topic, the first outcome is a first student grade, and the second outcome is a second student grade.

7. The method of claim 1, further comprising:
tracking rendering of the educational content files in the ordered playlist in real-time; and
presenting a progress tracker to the user.

8. The method of claim 7, further comprising:
determining a velocity of rendering of the educational content files in the ordered playlist; and
based on the velocity, updating the ordered playlist and presenting the updated playlist to the user.

9. The method of claim 1, further comprising:
generating the learning profile for the user based on records of the user's historical access to files in the educational content repository.

10. A method comprising:
at a server system comprising one or more processors and memory storing instructions for execution by the one or more processors:
receiving an input including an educational objective for a user and a finite duration of time for completion of the educational objective; and
responsive to the input:
selecting, from an educational content repository, a plurality of educational content files that meet the educational objective,
selecting a subset of educational content files from the plurality of educational content files based on a learning profile associated with the user and that is estimated to be rendered by the user within the finite duration of time,
determining an order for the educational content files in the subset, wherein the order is optimized to achieve the educational objective for the user,
generating, using the order, an ordered playlist of the educational content files in the subset, wherein the ordered playlist is estimated to be rendered by the user within the finite duration of time and is optimized to achieve the educational objective for the user, and
presenting the ordered playlist to the user.

11. The method of claim 10, further comprising:
determining a first outcome that is estimated to occur if the user plays the entirety of the ordered playlist within the finite duration of time; and
concurrent to presenting the ordered playlist to the user, presenting the first outcome to the user.

12. The method of claim 11, wherein the user is a student, the educational objective is an assessment in a particular topic, and the first outcome is a student grade.

13. The method of claim 10, further comprising:
selecting a second subset of educational content files from the plurality of educational content files that is estimated to be rendered by the user within the finite duration of time;
determining a second order for the educational content files in the second subset, wherein the second order is optimized to achieve the educational objective for the user;
generating, using the second order, a second ordered playlist of the educational content files in the second subset, wherein the second ordered playlist is estimated to be rendered by the user within the effective time and is optimized to achieve the educational objective for the user; and
presenting the second ordered playlist to the user.

14. The method of claim 13, further comprising:
determining a second outcome that is estimated to occur if the user plays the entirety of the second ordered playlist within the finite duration of time; and
concurrent to presenting the second ordered playlist to the user, presenting the second outcome to the user.

15. The method of claim 14, wherein the user is a student, the educational objective is an assessment in a particular topic, the first outcome is a first student grade, and the second outcome is a second student grade.

16. The method of claim 10, further comprising:
tracking rendering of the educational content files in the ordered playlist in real-time; and
presenting a progress tracker to the user.

17. The method of claim 16, further comprising:
determining a velocity of rendering of the educational content files in the ordered playlist; and
based on the velocity, updating the ordered playlist and presenting the updated playlist to the user.

18. The method of claim 10, further comprising:
generating the learning profile for the user based on records of the user's historical access to files in the educational content repository.
